(19) United States
(12) Patent Application Publication
(10) Pub. No.: US 2024/0242168 A1
(43) Pub. Date: Jul. 18, 2024

(54) Optimizing Fit of Products in Thermally-Controlled Packages

(71) Applicant: Pelican Products, Torrance, CA (US)

(72) Inventor: Kai Goellner, Saint Paul, MN (US)

(21) Appl. No.: 18/096,917

(22) Filed: Jan. 13, 2023

(51) Int. Cl. G06Q 10/0832; G06Q 10/083

(52) U.S. Cl. CPC G06Q 10/0832; G06Q 10/0838

(57) ABSTRACT

An optimal set of thermally-controlled packaging solutions is determined to reduce a cost of transporting a target set of temperature-sensitive products. This may include: (A) identifying, based on metadata associated with a plurality of thermally-controlled packaging solutions and metadata associated with a plurality of temperature-sensitive products: a plurality of thermally-controlled packaging solutions and corresponding sets of temperature-sensitive products; (B) calculating, for each of the plurality of thermally-controlled packaging solutions, a corresponding estimate of a thermal performance of the thermally-controlled packaging solution, based on thermal requirements of the temperature-sensitive product; and (C) performing an optimization method that optimizes the cost of transporting the target set of temperature-sensitive products based on the corresponding sets of temperature-sensitive products and the corresponding estimates of thermal performance, thereby identifying the optimal set of thermally-viable thermally-controlled packaging solutions.

### BACKGROUND

Customers seek packaging solutions (such as cases, coolers, and other kinds of containers) to ship and otherwise transport a wide variety of products. In many such cases, such as when shipping medical supplies, the payloads to be transported must be maintained within a specified temperature range for at least some specified minimum amount of time. In such cases, the customers have thermal requirements that must be satisfied by the packaging solutions that they select to transport their payloads. Each such payload may include a plurality of products, each having its own dimensions. Each potential packaging solution has its own dimensions and thermal performance specifications.

Attempting to match a set of payloads with packaging solutions that are capable of satisfying containment of the payloads and satisfying the payloads' thermal requirements is a challenging task. Customers also seek to minimize the total shipping weight of the set of payloads in order to minimize shipping cost. This makes the problem of matching payloads to packaging solutions even more challenging.

Currently, when a customer seeks to identify a set of packaging solutions for shipping a set of products in a way that satisfies the set of products' thermal requirements while minimizing shipping weight, one or more people typically attempt to perform the task manually. This can be a tedious, time-consuming, and error-prone process, especially if the number and variety of products to be shipped is large, if the thermal requirements of the product set are demanding, and if the customer seeks to reduce shipping weight (and hence cost) as much as possible. As a result, the packaging solutions that are selected tend to be far from optimal.

What is needed, therefore, are improved techniques for identifying packaging solutions that satisfy the thermal requirements of a set of products to be shipped, while minimizing shipping weight.

### SUMMARY

Embodiments of the present invention are directed to methods and systems for determining an optimal set of thermally-controlled packaging solutions to reduce a cost of transporting a target set of temperature-sensitive products. Such methods and systems include: (A) identifying, based on metadata associated with a plurality of thermally-controlled packaging solutions and metadata associated with a plurality of temperature-sensitive products: a plurality of thermally-controlled packaging solutions; and for each of the plurality of thermally-controlled packaging solutions, a corresponding set of temperature-sensitive products that fit into the thermally-controlled packaging solutions; wherein each corresponding set of temperature-sensitive products is a subset of the target set of temperature-sensitive products. Such methods and systems also include: (B) calculating, for each of the plurality of thermally-controlled packaging solutions, a corresponding estimate of a thermal performance that the thermally-controlled packaging solution would provide each temperature-sensitive product in the corresponding set of temperature-sensitive products that corresponds to the thermally-controlled packaging solution, based on thermal requirements of the temperature-sensitive product. Such methods and systems also include: (C) performing an optimization method that optimizes the cost of transporting the target set of temperature-sensitive products based on the corresponding sets of temperature-sensitive products and the corresponding estimates of thermal performance, thereby identifying the optimal set of thermally-viable thermally-controlled packaging solutions, wherein the optimal set of thermally-viable thermally-controlled packaging solutions is a proper subset of the plurality of thermally-controlled packaging solutions.

Other features and advantages of various aspects and embodiments of the present invention will become apparent from the following description and from the claims.

### BRIEF DESCRIPTION OF THE DRAWINGS

FIG. 1A is a dataflow diagram of a system that identifies thermally-viable thermally-controlled packaging solutions, suitable for transporting a target set of temperature-sensitive products, according to one embodiment of the present invention.

FIG. 1B is an illustration of initial thermally-controlled packaging solution data and initial temperature-sensitive product data in more detail according to one embodiment of the present invention.

FIG. 1C illustrates an example in which the thermal performance estimation module has generated thermal performance estimates corresponding to thermally-controlled packaging solutions.

FIG. 2 is a flowchart of a method that is performed by the system of FIG. 1A according to one embodiment of the present invention.

### DETAILED DESCRIPTION

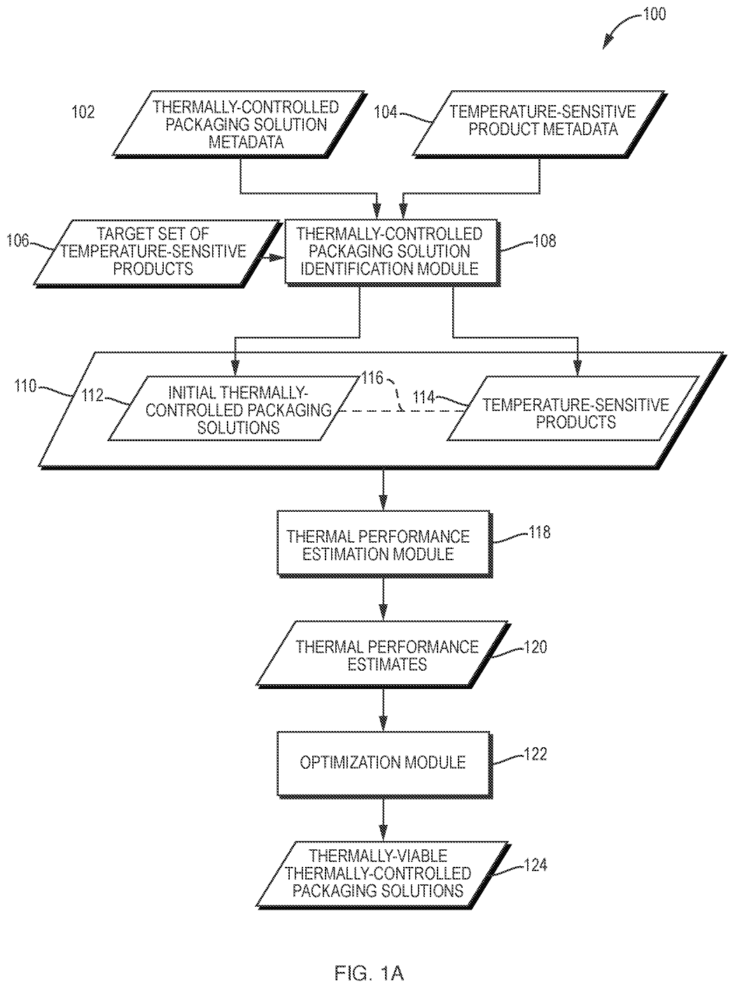

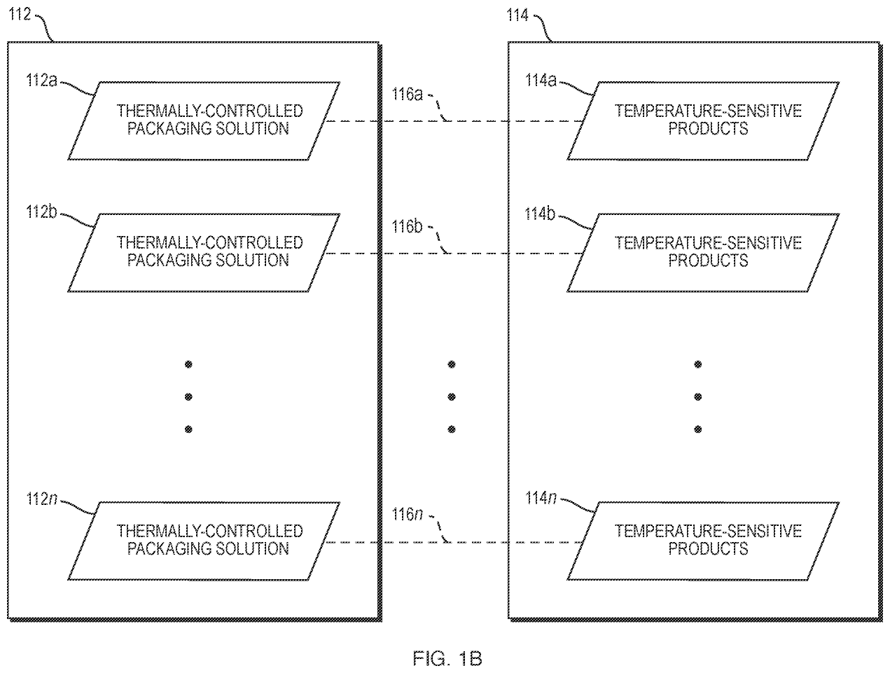

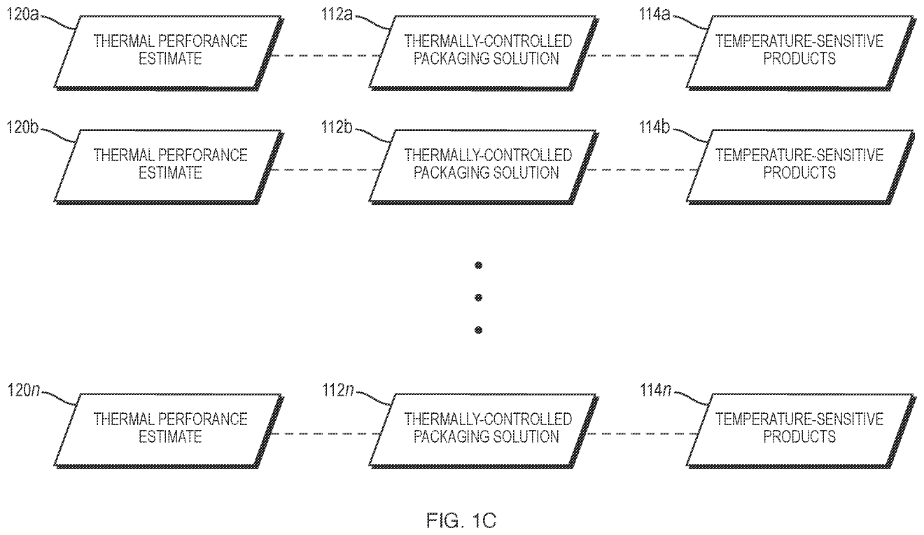

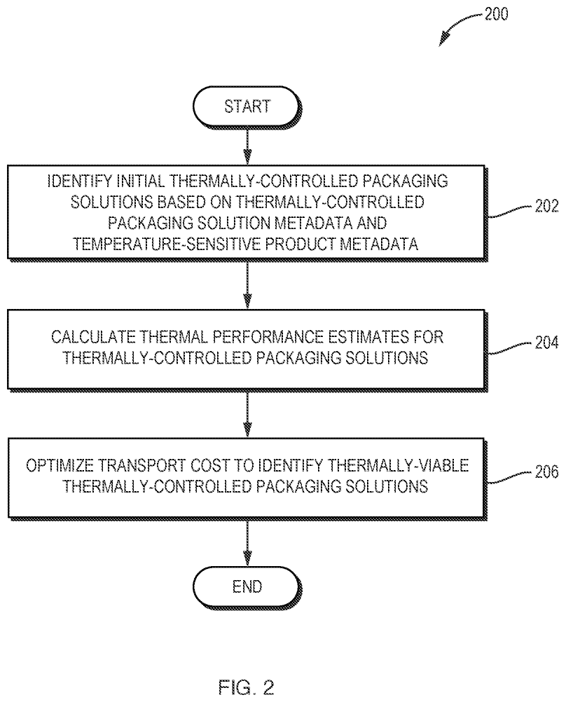

Referring to FIG. 1A, a dataflow diagram is shown of a system 100 that identifies thermally-viable thermally-controlled packaging solutions, suitable for transporting a target set of temperature-sensitive products, according to one embodiment of the present invention. Referring to FIG. 2, a flowchart is shown of a method 200 that is performed by the system 100 of FIG. 1A according to one embodiment of the present invention.

The system 100 includes metadata 102 associated with a plurality of thermally-controlled packaging solutions, also referred to herein as thermally-controlled packaging solution metadata 102. A “thermally-controlled packaging solution,” as that term is used herein, may, for example, be any kind of package, container, case, or other volume suitable for containing one or more products. Examples of thermally-controlled packaging solutions include, but are not limited to, reusable or single-use parcel solutions such as Credo Cube™, Credo™ Go, CoolGuard™, Sherpa Systems™, or NanoCool™ thermally-controlled packaging solutions, reusable or single-use bulk transportation solutions such as Credo™ Cargo, Credo™ Xtreme, Coolguard™ Flex, or Vertos thermally-controlled packaging solutions.

The term “thermally-controlled” refers to any feature(s) of a thermally-controlled packaging solution which controls, even partially, one or more thermal properties of one or more products that are contained, or may be contained, within the thermally-controlled packaging solution. Such a feature may, for example, be a passive feature (e.g., insulation of any kind, and/or a heat sink of any kind such as ice or other phase-change material) or an active feature (e.g., a powered heating or cooling element). As this description implies, a thermally-controlled packaging solution need not exercise complete control over the thermal properties (e.g., temperature) of products contained within it. For example, a packaging solution may be a “thermally-controlled” packaging solution even if the temperature of one or more products contained within it varies over time, as in the case of a thermally-controlled packaging solution that includes passive insulation, which permits the transfer of heat into and out of the thermally-controlled packaging solution. Instead, a “thermally-controlled packaging solution” may be “thermally-controlled” by virtue of containing any feature which controls, even partially, one or more thermal properties of one or more products that are contained, or may be contained, within the thermally-controlled packaging solution.

The thermally-controlled packaging solution metadata 102 may take any of a variety of forms. For example, the thermally-controlled packaging solution metadata 102 may include, for each of some or all of the thermally-controlled packaging solutions associated with the thermally-controlled packaging solution metadata 102, one or more of the following data fields, in any combination:
a description of the thermally-controlled packaging solution, which may, for example, be human-readable text describing the thermally-controlled packaging solution;
an inner dimensional length, width, and/or height of the thermally-controlled packaging solution;
an outer dimensional length, width, and/or height of the thermally-controlled packaging solution;
a width of the thermally-controlled packaging solution;
a height of the thermally-controlled packaging solution;
a weight of the thermally-controlled packaging solution; and
thermal characteristics required and/or useful for estimating performance of the thermally-controlled packaging solution, such as material materials, e.g., thermal conductivity, mass, density, specific heat, and/or latent heat.

The thermally-controlled packaging solution metadata 102 may include metadata for each of a plurality of thermally-controlled packaging solutions. The metadata fields (e.g., some or all of the fields listed above) may be the same or differ for different ones of the plurality of thermally-controlled packaging solutions. Furthermore, different instances of the same metadata field, associated with different ones of the plurality of thermally-controlled packaging solutions, may have different values. For example, different thermally-controlled packaging solutions may have different widths, heights, weights, thermal characteristics, etc. Such variations with the thermally-controlled packaging metadata 102 contribute to the difficulty of the problem of finding optimal thermally-controlled packaging solutions for transporting any particular set of temperature-sensitive products.

The system 100 also includes metadata 104 associated with a plurality of temperature-sensitive products, also referred to herein as temperature-sensitive product metadata 104. A “temperature-sensitive product,” as that term is used herein, may, for example, be any kind of product whose quality, performance, and/or other characteristic of interest is or may be affected by changes in temperature of the product and/or the product's environment. For example, a temperature-sensitive product may be a product that requires and/or benefits from temperature control. For example, an adhesive, photoresist, or polymer may be a temperature-sensitive product, as that term is used herein. Examples of temperature-sensitive products include, but are not limited to, food products, pharmaceuticals such as biologic medicines and vaccines, and other critical lifesaving products such as medical devices, blood, and donor organs.

The temperature-sensitive product metadata 104 may take any of a variety of forms. For example, the temperature-sensitive product metadata 104 may include, for each of some or all of the temperature-sensitive products associated with the temperature-sensitive product metadata 104, one or more of the following data fields, in any combination:
a description of the temperature-sensitive product, which may, for example, be human-readable text describing the temperature-sensitive product;
an outer dimensional length of the temperature-sensitive product;
a width of the temperature-sensitive product;
a height of the temperature-sensitive product;
a weight of the temperature-sensitive product; and
a temperature control range of the temperature-sensitive product (e.g., an upper and/or lower temperature bound at which the temperature-sensitive product is desired to be maintained during transport);
a thermal duration requirement of the temperature-sensitive product (e.g., a minimum amount of time (e.g., number of hours) during which the temperature-sensitive product is desired to be maintained within the temperature-sensitive product's temperature control range, given the temperature-sensitive product's ambient temperature profile); and
an ambient temperature profile that the temperature-sensitive product must be qualified to ship in.

Regarding the temperature control range, it may be helpful to understand that a typical refrigerated product may be regulated to be maintained between a particular range of temperatures, such as between 2° C. and 8° C. Embodiments of the present invention may use such a temperature control range to estimate the thermal duration that a particular thermally-controlled packaging solution will provide. For example, the same thermally-controlled packaging solution will provide a different thermal duration for a temperature-sensitive product having a temperature control range of 2-8° C. than for a temperature-sensitive product having a temperature control range of 2-25° C.

Regarding the ambient temperature profile, such a profile may, for example, include a temperature vs. time description (e.g., in table form), that represents the external heat load that the thermally-controlled packaging solution is subjected to during different periods of time. For example, a particular ambient temperature profile may indicate that the thermally-controlled packaging solution is subjected to a temperature of 22 degrees for 4 hours, then a temperature of 35 degrees for 2 hours, then a temperature of 30 degrees for 12 hours, then a temperature of 35 degrees for 6 hours. This is merely one example of a temperature profile which includes pairs of durations (e.g., hours) and corresponding temperatures, each of which may have any values.

The system 100 also includes data 106 representing a target set of temperature-sensitive products, also referred to herein as target temperature-sensitive product data 106. In general, the target temperature-sensitive product data 106 may represent a plurality of products which are desired to be transported in a thermally-controlled packaging solution. Any reference herein to “the target set of temperature-sensitive products” should be understood to refer to the temperature-sensitive products that are represented by the target temperature-sensitive product data 106. The target temperature-sensitive product data 106 may take any of a variety of forms. The target temperature-sensitive product data 106 may, for example, specify some or all of the temperature-sensitive products represented by the temperature-sensitive product metadata 104. The target temperature-sensitive product data 106 may include, for example, order history data indicating, for each of one or more previous orders, the set of temperature-sensitive products and the quantity present in that order as well as potential constraints on the arrangement (e.g., location and/or orientation) of those products within one or more thermally-controlled packaging solutions in that order.

The system 100 also includes a thermally-controlled packaging solution identification module 108. The thermally-controlled packaging solution identification module 108 receives as input the thermally-controlled packaging solution metadata 102, the temperature-sensitive product metadata 104, and the target set of temperature-sensitive product data 106, and generates, based on those inputs, data 112 representing a plurality of thermally-controlled packaging solutions, also referred to herein as initial thermally-controlled packaging solution data 112 (FIG. 2, operation 202). Any reference herein to “the initial thermally controlled packaging solutions” should be understood to refer to the initial thermally-controlled packaging solutions that are represented by the initial thermally-controlled packaging solution data 112.

The initial thermally-controlled packaging solution data 112 may be associated with data 114 (also referred to herein as initial temperature-sensitive product data) representing a plurality of sets of temperature-sensitive products that fit into the initial thermally-controlled packaging solutions. Any reference herein to “the initial temperature-sensitive products” should be understood to refer to the sets of initial temperature-sensitive products that are represented by the initial temperature-sensitive product data 114. The thermally-controlled packaging solution identification module 108 may, in operation 202, output both the initial thermally-controlled packaging solution data 112 and the initial temperature-sensitive product data 114 as part of initial solution data 110.

The association 116 between the initial thermally-controlled packaging solution data 112 and the initial temperature-sensitive product data 114 may be generated, represented, and stored in any of a variety of ways. For example, the initial thermally-controlled packaging solution data 112 may include the initial temperature-sensitive product data 114. As another example, the initial thermally-controlled packaging solution data 112 may include one or more pointers to the initial temperature sensitive product data 114.

Referring to FIG. 1B, an illustration of the initial thermally-controlled packaging solution data 112 and the initial temperature-sensitive product data 114 is shown in more detail according to one embodiment of the present invention. As shown therein, the initial thermally-controlled packaging solution data 112 may include data representing a plurality of thermally-controlled packaging solutions in the form of thermally-controlled packaging solution data 112a-n, where n may be any number. Each unit of the thermally-controlled packaging solution data 112a-n (e.g., thermally-controlled packaging solution data 112a, thermally-controlled packaging solution data 112b, etc.) may represent a distinct initial thermally-controlled packaging solution.

Similarly, the initial temperature-sensitive product data 114 may include data representing a plurality of sets of temperature-sensitive products in the form of temperature-sensitive product data 114a-n. Each unit of the temperature-sensitive product data 114a-n (e.g., temperature-sensitive product data 114a, temperature-sensitive product data 114b, etc.) may represent a corresponding set of initial temperature-sensitive products.

Any such set of initial temperature-sensitive products may include one or a plurality of temperature-sensitive products. For example, the initial sets of temperature-sensitive products may include a plurality of such sets, each of which includes a plurality of temperature-sensitive products (where the numbers of products in such sets may be the same as or differ from each other in any way). Any two sets within the sets of initial temperature sensitive products may be disjoint (i.e., not contain any temperature-sensitive products in common) or overlap in any way (e.g., contain one or more temperature-sensitive products in common with each other).

As mentioned above, the initial thermally-controlled packaging solutions may be associated with corresponding temperature-sensitive products, represented by the initial temperature-sensitive product data 114, as indicated by associations 116. An example of this is shown in more detail in FIG. 1B, in which the initial thermally-controlled packaging solution data 112 includes initial thermally-controlled packaging solution data units 112a-n, and in which the initial temperature-sensitive product data 114 includes initial temperature-sensitive product data units 114a-n, where n may be any number. Each of the initial thermally-controlled packaging solution data units 112a-n may represent a corresponding distinct initial thermally-controlled packaging solution, such that the initial thermally-controlled packaging solution data units 112a-n may represent a plurality of corresponding initial thermally-controlled packaging solutions. Similarly, each of the initial temperature-sensitive product data units 114a-n may represent a corresponding distinct initial temperature-sensitive product, such that the initial temperature sensitive product data units 114a-n may represent a plurality of corresponding initial temperature-sensitive products.

Each of the initial thermally-controlled packaging solution data units 112a-n may be associated with a corresponding distinct one of the initial temperature-sensitive product data units 114a-n, as shown in FIG. 1B by the associations 116a-n. As this implies, the initial thermally-controlled packaging solution represented by each of the initial thermally-controlled packaging solution data units 112a-n may be associated with a corresponding set of temperature-sensitive products represented by the initial temperature-sensitive product data unit that is associated with that initial thermally-controlled packaging solution data unit.

For example, in FIG. 1B, the initial thermally controlled packaging solution data unit 112a is associated 116a with the initial temperature-sensitive product data 114a, which implies that the initial thermally-controlled packaging solution represented by the initial thermally-controlled packaging solution data unit 112a is associated with the set of temperature-sensitive products represented by the initial temperature-sensitive product data unit 114a. Similarly, for example, the initial thermally controlled packaging solution data unit 112b is associated 116b with the initial temperature-sensitive product data 114b, which implies that the initial thermally-controlled packaging solution represented by the initial thermally-controlled packaging solution data unit 112b is associated with the set of temperature-sensitive products represented by the initial temperature-sensitive product data unit 114b.

The set of temperature-sensitive products that is represented by each of the initial temperature-sensitive product data units 114a-n may be chosen by the thermally-controlled packaging solution identification module 108 to fit within the corresponding initial thermally-controlled packaging solutions represented by the initial thermally-controlled packaging solution data units 112a-n. For example, the set of temperature-sensitive products that is represented by the initial temperature-sensitive product data units 114a may be chosen by the thermally-controlled packaging solution identification module 108 to fit within the corresponding initial thermally-controlled packaging solution represented by the initial thermally-controlled packaging solution data unit 112a. Similarly, for example, the set of temperature-sensitive products that is represented by the initial temperature-sensitive product data units 114b may be chosen by the thermally-controlled packaging solution identification module 108 to fit within the corresponding initial thermally-controlled packaging solution represented by the initial thermally-controlled packaging solution data unit 112b.

The thermally-controlled packaging solution identification module 108 may select each of the sets of initial temperature-sensitive products to be a subset (e.g., a proper subset) of the target set of temperature-sensitive products. For example, each of the initial temperature-sensitive product data units 114a-n may represent a corresponding set of initial temperature-sensitive products, wherein each such set is a subset (e.g., a proper subset) of the target set of temperature-sensitive products. Some or all of the initial sets of temperature-sensitive products may differ from each other in any of a variety of ways. For example, one such set may include one or more temperature-sensitive products that are not included in another such set.

The thermally-controlled packaging solution identification module 108 may, as part of generating some or all of the initial solution data 110 in operation 202, constrain orientations of temperature-sensitive products in the initial set of thermally-controlled packaging solutions to a predetermined set of allowable orientations, or to a predetermined set of allowable combinations of orientations.

The system 100 also includes a thermal performance estimation module 118, which receives some or all of the initial solution data 110 (e.g., the initial thermally-controlled packaging solution data 112 and/or the initial temperature-sensitive product data 114) as input, and which generates, based on that input, a set of thermal performance estimates 120 (FIG. 2, operation 204). For example, the thermal performance estimation module 118 may generate, for each of the initial thermally-controlled packaging solutions S, and for each temperature-sensitive product P within each of the initial thermally-controlled packaging solutions, a corresponding estimate of a thermal performance that the thermally-controlled packaging solution S′ would provide to temperature-sensitive product P. Each such thermal performance estimate for the solution/product combination (S, P) may, for example, represent the amount of time (e.g., number of hours) that the thermally-controlled packaging solution S is expected to maintain the temperature sensitive product P within its temperature control range, given the temperature-sensitive product P's ambient temperature profile and the thermal properties of the thermally-controlled packaging solution S. The thermal performance estimation module 118 may, for example, generate each such estimate based on thermal requirements of one or more of the temperature-sensitive products within the initial set of temperature-sensitive products. In the optimization process performed by the optimization module 122 (see description below), for each of the initial sets of temperature-sensitive products, the minimum duration requirement of the temperature-sensitive products in that set may be used as the limiting case for a thermally-controlled packaging solution to be deemed to satisfy the needs of that set as a whole.

FIG. 1C shows an example in which the thermal performance estimation module 118 has generated thermal performance estimates 120a-n corresponding to thermally-controlled packaging solutions 112a-n. For example, thermal performance estimate 120a is an estimate of thermal performance of the thermally-controlled packaging solution represented by thermally-controlled packaging solution data 112a, and thermal performance estimate 120b is an estimate of thermal performance of the thermally-controlled packaging solution represented by thermally-controlled packaging solution data 112b.

For example, returning to FIG. 1B, the thermal performance estimation module 118 may generate, for the initial thermally-controlled packaging solution represented by the initial thermally-controlled packaging solution data unit 112a, a corresponding estimate of a thermal performance that the thermally-controlled packaging solution would provide to each temperature-sensitive product in the initial set of temperature-sensitive products represented by the initial temperature-sensitive product data unit 114a. The thermal performance estimation module 118 may, for example, generate that estimate based on thermal requirements of one or more of the temperature-sensitive products within the initial set of temperature-sensitive products represented by the initial temperature-sensitive product data unit 114a.

Similarly, the thermal performance estimation module 118 may generate, for the initial thermally-controlled packaging solution represented by the initial thermally-controlled packaging solution data unit 112b, a corresponding estimate of a thermal performance that the thermally-controlled packaging solution would provide to each temperature-sensitive product in the initial set of temperature-sensitive products represented by the initial temperature-sensitive product data unit 114b. The thermal performance estimation module 118 may, for example, generate that estimate based on thermal requirements of one or more of the temperature-sensitive products within the initial set of temperature-sensitive products represented by the initial temperature-sensitive product data unit 114b.

The thermal performance estimates generated by the thermal performance estimation module 118 for different ones of the initial thermally-controlled packaging solutions may differ from each other in any of a variety of ways. For example, such estimates may differ from each other due to any one or more of the following: the designs of the initial thermally-controlled packaging solutions; differences in energy barriers (e.g., insulation) among the initial thermally-controlled packaging solutions; and differences in energy absorption characteristics (e.g., cooling means) among the initial thermally-controlled packaging solutions, such as differences in thickness and/or mass.

The system 100 also includes an optimization module 122, which performs an optimization method that optimizes (e.g., minimizes or otherwise reduces) the cost of transporting the target set of temperature-sensitive products, based on the initial sets of temperature-sensitive products and the thermal performance estimates 120. The optimization module 122 outputs, as a result of performing the optimization method, data 124 representing a reduced set of thermally-viable thermally-controlled packaging solutions (also referred to here as thermally-viable thermally-controlled packaging solution data 124) (FIG. 2, operation 206). The reduced set of thermally-viable thermally-controlled packaging solutions may be a subset (e.g., a proper subset) of the initial set of thermally-controlled packaging solutions. Any reference herein to “the thermally-viable thermally controlled packaging solutions” should be understood to refer to the thermally-viable thermally controlled packaging solutions that are represented by the thermally-viable thermally-controlled packaging solution data 124.

The cost that is optimized (e.g., minimized or otherwise reduced) by the optimization method performed by the optimization module 122 may take any of a variety of forms. Embodiments of the present invention are not limited to use in connection with any particular type of cost. Instead, embodiments of the present invention may be used to optimize (e.g., minimize or otherwise reduce) any type of cost, no matter how that cost is defined. For example, the cost that is optimized may, for example, be a function of any one or more of the following, in any combination:
a price of transporting the target set of temperature-sensitive products (which may, include, for example, outgoing costs and/or return (incoming) costs, in any combination);
CO₂ emissions generated by transporting the target set of temperature-sensitive products; and
one or more landfill impacts of transporting the target set of temperature-sensitive products.

The optimization method performed by the optimization module 122 may, for example, take into account an order profile representing one or more orders for temperature-sensitive products. For example, the initial temperature-sensitive product data 114 may include one or more order profiles, where each such order profile includes order data representing a corresponding order (which may, for example, be a historical (i.e., actual previous) order or a forecasted future order (whether or not that order actually is executed in the future)). The order data representing a particular order may include, for example, data representing any one or more of the following:
a quantity of payload items (e.g., temperature-sensitive product(s)) in the order; and
a frequency with which the quantity of payload items is expected to be shipped over a given time period (e.g., a week, a month, or a year).

The optimization method performed by the optimization module 122 may include generating the thermally-viable thermally-controlled packaging solution data 124 based, at least in part, on the order profile.

In cases in which the optimization module 122 uses such an order profile in the optimization method, the generation of the thermal performance estimates 120 by the thermal performance estimation module 118 may include, for each of the initial thermally-controlled packaging solutions representing by the initial thermally-controlled packaging solution data, risk-categorizing the corresponding estimate of thermal performance (in the thermal performance estimates 120) into a performance bin based on an estimated likelihood that the thermally-controlled packaging solution will perform to the thermal duration requirement(s) of some or all of the temperature-sensitive products within that thermally-controlled packaging solution. The optimization method performed by the optimization module 122 may include identifying an optimal set of temperature-sensitive products for each unique thermal performance bin.

The optimization method performed by the optimization module 122 may include selecting a subset of the initial thermally-controlled packaging solutions by selecting the lowest-cost thermally-controlled packaging solution for each order profile node for each thermal performance bin using Integer Linear Programming (ILP) or another optimization method.

The order profile may include a plurality of order profile nodes representing a corresponding plurality of orders. Each of the plurality of order profile nodes may include: a quantity of payload items in the corresponding order; and a frequency with which the quantity of payload items in the corresponding order is expected to be shipped over a given time period. The optimization method performed by the optimization module 122 may include identifying the optimal set of thermally-viable thermally-controlled packaging solutions to fulfill the order profile. Note that the order profile may be a histogram format of the orders from the customer. The optimization module 122 may flatten out this histogram to recreate a corresponding list of orders, which needs a temperature-controlled packaging solution or set of solutions to fulfill the order. When the optimization module 122 identifies the optimal set of thermally-viable thermally-controlled packaging solutions to fulfill the order profile, this may include identifying the optimal set of thermally-viable thermally-controlled packaging solutions that fulfill all orders that were recreated based on the order profile.

The optimization method performed by the optimization module 122 may include identifying a plurality of optimal sets of thermally-viable thermally-controlled packaging solutions (within the initial set of thermally-controlled packaging solutions), wherein each of the plurality of optimal sets of thermally-viable thermally-controlled packaging solutions is constrained by a predetermined maximum number of thermally-controlled packages.

Although not shown in FIG. 2, the system 100 and method 200 may also generate a report based on the thermally-viable thermally-controlled packaging solution data 124, store that report in any form, and output that report in any way (such as by displaying the report on a display screen). Such a report may include, for example, data representing an estimated transient thermal performance of each of the thermally-controlled packaging solutions in the thermally-viable thermally-controlled packaging solutions. The report may, for example, include a visual representation of the temperature-sensitive product packing orientation for all packaging/product combinations, such as an exploded diagram of how the temperature-sensitive products are to be placed inside the thermally-controlled packaging solution in order to maximize fitment.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention perform an optimization method on data using inherently computer-implemented techniques. Such optimization could not be performed mentally or manually and are inherently rooted in computer technology.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

1. A method for determining an optimal set of thermally-controlled packaging solutions to reduce a cost of transporting a target set of temperature-sensitive products, the method comprising:
(A) identifying, based on metadata associated with a plurality of thermally-controlled packaging solutions and metadata associated with a plurality of temperature-sensitive products:
a plurality of thermally-controlled packaging solutions; and
for each of the plurality of thermally-controlled packaging solutions, a corresponding set of temperature-sensitive products that fit into the thermally-controlled packaging solutions;
wherein each corresponding set of temperature-sensitive products is a subset of the target set of temperature-sensitive products;
(B) calculating, for each of the plurality of thermally-controlled packaging solutions, a corresponding estimate of a thermal performance that the thermally-controlled packaging solution would provide each temperature-sensitive product in the corresponding set of temperature-sensitive products that corresponds to the thermally-controlled packaging solution, based on thermal requirements of the temperature-sensitive product;
(C) performing an optimization method that optimizes the cost of transporting the target set of temperature-sensitive products based on the corresponding sets of temperature-sensitive products and the corresponding estimates of thermal performance, thereby identifying the optimal set of thermally-viable thermally-controlled packaging solutions, wherein the optimal set of thermally-viable thermally-controlled packaging solutions is a proper subset of the plurality of thermally-controlled packaging solutions.

2. The method of claim 1, wherein the metadata associated with the plurality of thermally-controlled packaging solutions comprises at least one of a description, an inner dimensional length, an outer dimensional length, a width, a height, a weight, and thermal characteristics required for performance estimating.

3. The method of claim 1, wherein the metadata associated with the plurality of temperature-sensitive products includes at least one of a description, a length, a width, a height, a weight, a temperature control range, a thermal duration requirement, and an ambient temperature profile of each of the plurality of temperature-sensitive products.

4. The method of claim 3, wherein the metadata associated with the plurality of temperature-sensitive products includes an order profile, the order profile comprising a plurality of order profile nodes representing a corresponding plurality of orders, wherein each of the plurality of order profile nodes comprises:
a quantity of payload items in the corresponding order; and
a frequency with which the quantity of payload items in the corresponding order is expected to be shipped over a given time period;
and wherein performing the optimization method comprises identifying the optimal set of thermally-viable thermally-controlled packaging solutions to fulfill the order profile.

5. The method of claim 4, wherein (B) comprises, for each of the plurality of thermally-controlled packaging solutions, risk-categorizing the corresponding estimate of the thermal performance into a performance bin based on an estimated likelihood that the thermally-controlled packaging solution will perform to the minimum thermal requirement of all of the products in the plurality of thermally-controlled packaging solutions.

6. The method of claim 5, wherein (C) comprises identifying an optimal set for each unique thermal performance ‘bin’.

7. The method of claim 6, wherein (C) comprises selecting a subset of the plurality of thermally-controlled packaging solutions by selecting the lowest cost thermally-controlled packaging solution for each order profile ‘node’ for each thermal performance ‘bin’ using a particular optimization method.

8. The method of claim 7, wherein the particular optimization method comprises Integer Linear Programming (ILP).

9. The method of claim 1, wherein (C) comprises identifying a plurality of optimal sets of thermally-viable thermally-controlled packaging solutions, wherein each of the plurality of optimal sets of thermally-viable thermally-controlled packaging solutions is constrained by a predetermined maximum number of thermally-controlled packages.

10. The method of claim 1, wherein (A) comprises constraining orientations of temperature-sensitive products in the plurality of thermally-controlled packaging solutions to a predetermined set of allowable orientations.

11. The method of claim 1, wherein (A) comprises constraining orientations of temperature-sensitive products in the plurality of thermally-controlled packaging solutions to a predetermined set of allowable combinations of orientations.

12. The method of claim 1, wherein at least one of the thermally-viable thermally-controlled packaging solutions in the optimal set of thermally-viable thermally-controlled packaging solutions includes a plurality of temperature-sensitive products.

13. The method of claim 1, wherein the cost optimized in (C) includes at least one of a price of transporting the target set of temperature-sensitive products, a price of the thermally-controlled packaging solution set, CO₂ emissions generated by transporting the target set of temperature-sensitive products, and landfill impacts of transporting the target set of temperature-sensitive products.

14. The method of claim 1, further comprising:
(D) generating a report of the optimal set of thermally-viable thermally-controlled packaging solutions.

15. The method of claim 14, wherein the report includes data representing an estimated transient thermal performance of each of the thermally-controlled packaging solutions in the optimal set of thermally-viable thermally-controlled packaging solutions.

16. The method of claim 14, wherein the report includes a visual representation of the temperature-sensitive product packing orientation is shown in the report for all packaging/product combinations.
